(19) United States
(12) Patent Application Publication
(10) Pub. No.: US 2009/0076817 A1
(43) Pub. Date: Mar. 19, 2009

(54) METHOD AND APPARATUS FOR RECOGNIZING SPEECH

(75) Inventors: Hyung Bae JEON, Daejeon (KR); Kyu Woong HWANG, Daejeon (KR); Seung Hi KIM, Daejeon (KR); Hoon CHUNG, Gangwon-do (KR); Jun PARK, Daejeon (KR); Yun Keun LEE, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejeon (KR)

(21) Appl. No.: 12/047,634

(22) Filed: Mar. 13, 2008

(30) Foreign Application Priority Data
Sep. 19, 2007 (KR) 10-2007-95540

(51) Int. Cl. G10L 15/00

(52) U.S. Cl. 704/240

(57) ABSTRACT

Provided are an apparatus and method for recognizing speech, in which reliability with respect to phoneme-recognized phoneme sequences is calculated and performance of speech recognition is enhanced using the calculated results. The method of recognizing speech includes the steps of: determining a boundary between phonemes included in character sequences that are phonetically input to detect each phoneme interval; calculating reliability according to a probability that a phoneme indicated by the detected phoneme interval corresponds to a phoneme included in a predefined phoneme model; calculating a phoneme alignment cost with respect to the character sequences based on the calculated reliability and a pre-trained and stored phoneme recognition probability distribution; and performing phoneme alignment based on the calculated phoneme alignment cost to perform speech recognition on the input character sequences. As a result, reliability with respect to the phoneme-recognized phoneme sequences can be calculated, and the performance of speech recognition can be enhanced using the calculated results.

### CROSS-REFERENCE TO RELATED APPLICATION

This application claims priority to and the benefit of Korean Patent Application No. 2007-0095540, filed Sep. 19, 2007, the disclosure of which is incorporated herein by reference in its entirety.

### BACKGROUND

1. Field of the Invention

The present invention relates to a method and apparatus for recognizing speech and, more specifically, to multi-stage speech recognition method and apparatus, in which acoustic and linguistic searches are conducted separately from each other.

2. Discussion of Related Art

A conventional method of recognizing speech includes a method in which acoustic and linguistic searches are simultaneously conducted, and a multi-stage speech recognition method in which acoustic and linguistic searches are conducted separately from each other. In the acoustic search, phonemes are extracted from input speech, and in the linguistic search, a word that is most similar to input speech is searched based on the extracted phonemes.

The method, in which the acoustic and linguistic searches are simultaneously conducted, results in increased memory requirements and deteriorated speech recognition speed.

In view of this drawback, the multi-stage speech recognition method, in which the acoustic and linguistic searches are conducted separately from each other, is introduced. Since the acoustic and linguistic searches are conducted separately from each other in the multi-stage speech recognition method, speech recognition speed may be enhanced and memory requirements may be reduced. The multi-stage speech recognition method includes a phone distributed speech recognition (phone-DSR) in which phoneme recognition is performed by an embedded terminal and a word recognition is performed by a server, and a method in which both the phoneme recognition and the word recognition are performed by the embedded terminal. The configuration and operation of the conventional multi-stage speech recognition apparatus will be described below with reference to FIG. 1.

FIG. 1 is a block diagram of a conventional multi-stage speech recognition apparatus.

The conventional multi-stage speech recognition apparatus includes a speech feature extractor 102, a phoneme recognition unit 104, an acoustic model 114, a word recognition unit 106 and a phoneme error model 116.

The speech feature extractor 102 extracts speech feature data from an input speech signal to output the extracted results to the phoneme recognition unit 104.

The phoneme recognition unit 104 determines through a viterbi search, whether any phoneme is most similar to the extracted feature data with reference to the acoustic model 114, to output the determined results to the word recognition unit 106.

The word recognition unit 106 searches for a word that is most similar to the input speech based on phoneme sequences output from the phoneme recognition unit 104, and the phoneme error model 116.

In the multi-stage speech recognition method, the phoneme recognition that requires relatively less calculation processes is performed during the acoustic search, and word sequences that are the most similar to a word subject to the search is searched based on the phoneme sequences recognized in the acoustic search during the linguistic search. Here, since a phoneme recognizer that performs the phoneme recognition cannot perfectly perform the phoneme recognition, errors are generally included in the phoneme sequences output from the phoneme recognizer. Due to the errors, the phoneme error model 116 that is a probability model with respect to errors pre-trained in the process of model training is used during the linguistic search. A conventional training process of the phoneme error model 116 will be described below with reference to FIG. 2.

FIG. 2 is a flowchart illustrating the conventional training process of the phoneme error model.

Speech is input into a system for training the phoneme error model (step 201), and the system recognizes phonemes of the input speech (step 203) and aligns the recognized phoneme sequences and answer phoneme sequences (step 205). Then, probabilities of substitution, insertion and deletion of each phoneme are calculated (step 207), and the calculated probabilities are accumulated. When the accumulation of the probabilities with respect to every training DB is completed, a phoneme error model 220 is updated according to the accumulated probabilities (step 209), and it is determined whether the training of the phoneme error model will be continuously performed or not (step 211).

Meanwhile, when the word that is most similar to the input speech is determined by the word recognition unit 106 based on the phoneme error model 116, a Discrete Hidden Markov Model (DHMM) or a Dynamic Time Warping (DTW) may be used. The DTW is a pattern matching algorithm having non-linear time-normalization, and may be used to search for an optimal word using recognized phoneme sequences. This will be described below with reference to FIGS. 3A and 3B.

FIGS. 3A and 3B illustrate a process of searching for optimal word sequences using “ABC” as a result of phoneme recognition in the acoustic search. Here, based on reference phoneme sequences, phoneme-recognized phoneme sequences are substituted, deleted or inserted, and a word that requires the lowest phoneme alignment cost caused by the substitution, insertion and deletion is selected as the optimal word.

The phoneme alignment cost is obtained from the phoneme error model 116 that is described with reference to FIG. 2, and the phoneme alignment cost will be described with reference to FIG. 3 and is defined by the following Table 1.

TABLE 1

| | | Phoneme |
|---|---|---|
| Phoneme Alignment Method | | Alignment Cost |
| Insertion | | 1 |
| Deletion | | 1 |
| Substitution | Equal to a reference phoneme | 0 |
| | Different from a reference phoneme | 1 |

Referring to Table 1, as illustrated in FIG. 3A, phoneme alignment costs required in aligning phoneme-recognized phoneme sequences “ABC” based on reference phoneme sequences “AABD” can be calculated below. In the process of substituting a recognized phoneme “A” to a phoneme “A” of the reference word in step 311, the phoneme alignment cost is equal to “0”. In the process of deleting the phoneme “A” of the reference word in step 313, the phoneme alignment cost is equal to “1”. In the process of substituting the recognized phoneme “B” to the phoneme “B” of the reference word in step 315, the phoneme alignment cost is equal to “0”. In the process of substituting the recognized phoneme “C” to the phoneme “D” of the reference word in step 317, the phoneme alignment cost is equal to “1”. Accordingly, in case of the phoneme alignment illustrated in FIG. 3A, a sum of the phoneme alignment costs is 2 (0+1+0+1=2).

Similarly, referring to Table 1, as illustrated in FIG. 3B, phoneme alignment costs required in aligning phoneme-recognized phoneme sequences “ABBC” based on reference phoneme sequences “ABC” can be calculated below. The phoneme alignment cost for step 321 is “0”. The phoneme alignment cost for step 323 is “0”. The phoneme alignment cost for step 325 is “1”. The phoneme alignment cost for step 327 is “0”. Therefore, a sum of the phoneme alignment costs for the phoneme alignment of FIG. 3B is equal to 1 (0+0+1+0=1).

Therefore, as illustrated in FIGS. 3A and 3B, when only two cases of word recognition are performed with respect to the phoneme-recognized phoneme sequences “ABC”, the phoneme sequences “ABBC” that require a lower phoneme alignment cost are selected as the optimal word as illustrated in FIG. 3B.

In the multi-stage speech recognition method, it is important to precisely extract phonemes in the acoustic search process to deliver the extracted results to the linguistic search process. Therefore, when the performance of a phoneme recognizer that is used in the acoustic search process is deteriorated, it is difficult to search for the precisely corresponding word.

To increase a word recognition rate according to the performance of the phoneme recognizer, a method of delivering more information on phoneme-recognized phoneme sequences of the acoustic search process to the linguistic search process is requested.

### SUMMARY OF THE INVENTION

The present invention is directed to a method and apparatus for calculating reliability with respect to phoneme-recognized phoneme sequences and enhancing performance of speech recognition using the calculated results.

The present invention is also directed to a method of obtaining a phoneme recognition probability distribution that is used in calculating reliability of phoneme-recognized phoneme sequences.

Another purpose of the present invention may be understood by the following descriptions and exemplary embodiments.

One aspect of the present invention provides a method of recognizing speech comprising the steps of: determining a boundary between phonemes included in character sequences that are phonetically input to detect each phoneme interval; calculating reliability according to a probability that a phoneme indicated by the detected phoneme interval corresponds to a phoneme included in a predefined phoneme model; calculating a phoneme alignment cost with respect to the character sequences based on the calculated reliability and a pre-trained and stored phoneme recognition probability distribution; and performing phoneme alignment based on the calculated phoneme alignment cost to perform speech recognition on the input character sequences.

Another aspect of the present invention provides an apparatus for recognizing speech comprising: a phoneme interval detector for detecting each phoneme interval by determining a boundary between phonemes included in phonetically input character sequences; a reliability determination unit for calculating reliability according to probabilities that a phoneme indicated by each detected phoneme interval corresponds to each phoneme included in a predefined phoneme model; a reliability-based phoneme error model for storing a phoneme recognition probability distribution obtained by pre-training that a phonetically input phoneme is recognized as a phoneme; and a word recognition unit for calculating a phoneme alignment cost with respect to the character sequences based on the calculated reliability and the phoneme recognition probability distribution, and performing phoneme alignment based on the calculated phoneme alignment cost to perform speech recognition with respect to the character sequences.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a block diagram of a conventional multi-stage speech recognition apparatus;

FIG. 2 is a flowchart illustrating a conventional phoneme error model training process;

FIGS. 3A and 3B illustrate examples of a Dynamic Time Warping method;

FIG. 4 is a block diagram illustrating an apparatus for recognizing speech according to an exemplary embodiment of the present invention;

FIG. 5 illustrates an example of a probability that each detected phoneme interval is a phoneme of a predefined phoneme model according to an exemplary embodiment of the present invention;

FIGS. 6A to 6C illustrate a phoneme recognition probability distribution of a reliability-based phoneme error model according to an exemplary embodiment of the present invention; and

FIG. 7 is a flowchart illustrating a method of recognizing speech according to an exemplary embodiment of the present invention.

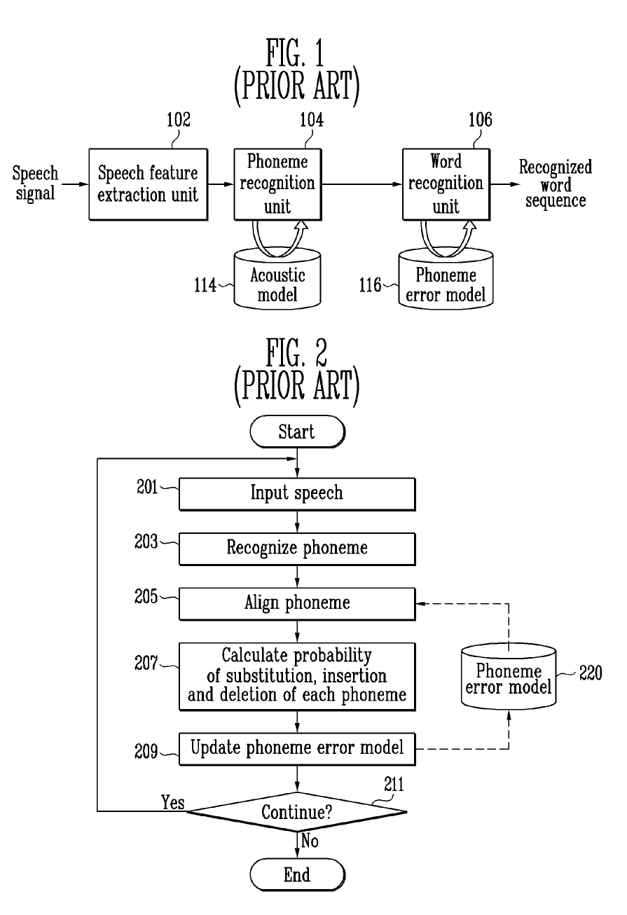

### DETAILED DESCRIPTION OF EMBODIMENTS

The present invention will now be described more fully hereinafter with reference to the accompanying drawings, in which exemplary embodiments of the invention are shown.

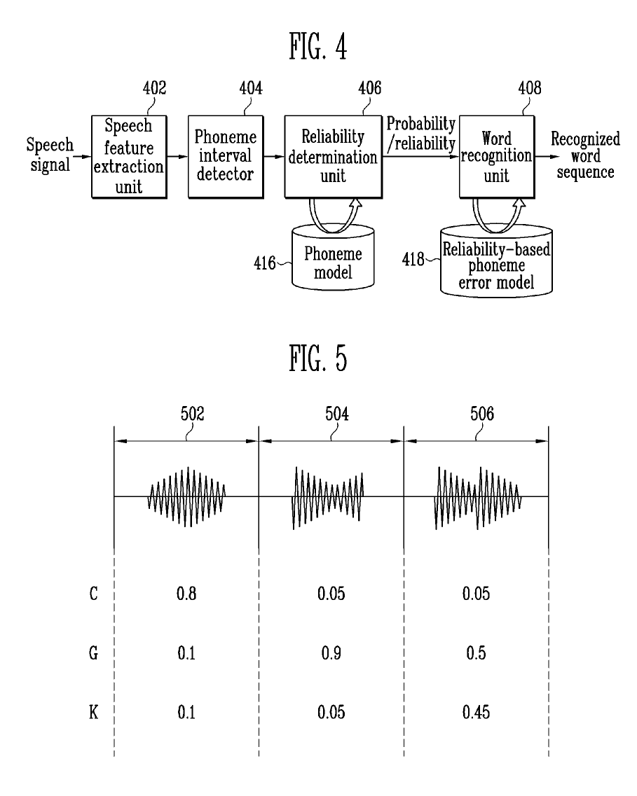

FIG. 4 is a block diagram of an apparatus for recognizing speech according to an exemplary embodiment of the present invention. The configuration and operation of the apparatus for recognizing speech will be described below with reference to FIG. 4.

The apparatus for recognizing speech according to the present invention includes a speech feature extraction unit 402, a phoneme interval detector 404, a reliability determination unit 406, a phoneme model 416, a word recognition unit 408 and a reliability-based phoneme error model 418.

The speech feature extraction unit 402 of the present invention analyzes an input speech signal to extract speech feature data and outputs the extracted speech feature data to the phoneme interval detector 404. Here, the speech feature data is extracted by a Mel Frequency Cepstral Coefficients (MFCC) extraction method in which speech is recognized by humans on a mel scale similar to a logarithm scale rather than a linear one. In addition to the above, a Linear Predictive Coding (LPC) extraction method in which speech is equally analyzed over every frequency band, a pre-emphasis extraction method that emphasizes the high frequency components to clearly distinguish speech from noise, and a window function extraction method in which distortion caused by disconnection generated when speech is analyzed by small segments is minimized can be used.

The phoneme interval detector 404 of the present invention analyzes the speech feature data output from the speech feature extraction unit 402 and determines a boundary between phonemes to detect a phoneme interval. The phoneme interval may be detected by comparing a spectrum of a previous frame with that of a current frame based on a time axis. Here, the spectrum may be compared by a distance measurement method that is based on the MFCC, and an energy zero crossing rate or a formant frequency may be used to distinguish voiced/voiceless sounds. In addition, the phoneme interval detector 404 may use phoneme interval information of phoneme recognition results obtained by a phoneme recognizer.

The reliability determination unit 406 of the present invention calculates likelihood by comparing patterns of the phoneme interval detected by the phoneme interval detector 404 with those of a phoneme included in the predefined phoneme model 416. Here, the likelihood may be calculated by a viterbi decoding method.

Here, a monophone-based phoneme model or a triphone-based phoneme model may be used for the phoneme model 416 according to an exemplary embodiment of the present invention. When the triphone-based phoneme model is used, outputs are produced based on a center phone. In the monophone, when “school” is expressed, four phonemes “S”, “K”, “UW”, and “L” are expressed. Meanwhile, in the triphone, each corresponding phoneme of the four phonemes is expressed together with information on its left and right phonemes, i.e., “sil-S+K”, “S−K+UW”, “K−UW+L”, “UW−L+sil”. The center phone refers to a middle phoneme of three phonemes represented in the triphone, i.e., a monosyllabic phoneme. When the triphone-based phoneme recognition method is used, requirements for defining a context between phonemes are added to increase performance of the phoneme recognition.

The reliability determination unit 406 of the present invention calculates a probability prob[q][i] that each phoneme interval q detected by the calculated likelihood is an i^{th} phoneme of N phonemes included in the predefined phoneme model 416. The probability may be calculated by the following Equation 1.

$$prob [ q ] [ i ] = \frac{likelihood [ q ] [ i ]}{{\sum }_{j = 1}^{N} likelihood [ q ] [ i ]} \qquad [ Equation 1 ]$$

In Equation 1, prob[q][i] denotes a probability that a phoneme indicated by a q^{th} phoneme interval of the detected phoneme intervals is an i^{th} phoneme of N phonemes included in the phoneme model, likelihood[q][i] denotes likelihood between the phoneme indicated by the q^{th} phoneme interval of the detected phoneme intervals and the i^{th} phoneme of N phonemes included in the phoneme model, and

$${\sum }_{j = 1}^{N} likelihood [ q ] [ j ]$$

denotes a sum of likelihood values between the phoneme indicated by the q^{th} phoneme interval of the detected phoneme intervals and each of N phonemes included in the phoneme model 416. Equation 1 will be described below with reference to FIG. 5.

FIG. 5 illustrates probabilities that each detected phoneme interval is each phoneme of a predefined phoneme model according to an exemplary embodiment of the present invention. It is assumed that three phonemes “C”, “G” and “K” are registered in the phoneme model 416 for simplicity.

Referring to FIG. 5, probabilities that phonemes indicated by a first interval 502 of the detected phoneme intervals are “C”, “G” and “K” of phonemes included in the phoneme model 416 are 0.8, 0.1 and 0.1, respectively. Therefore, there is the highest probability that the phoneme indicated by the first interval 502 is “C”. Further, probabilities that phonemes indicated by a second interval 504 are “C”, “G” and “K” of the phonemes included in the phoneme model 416 are 0.05, 0.9 and 0.05, respectively. Therefore, there is the highest probability that the phoneme indicated by the second interval 504 is “G”. In addition, probabilities that phonemes indicated by a third interval 506 of the detected phoneme intervals are “C”, “G” and “K” of the phonemes included in the phoneme model 416 are 0.05, 0.5 and 0.45, respectively. Therefore, there is the highest probability that the phoneme indicated by the third interval 506 is “G”. That is, according to the probabilities calculated by Equation 1, there is the highest probability that phoneme sequences of the detected phoneme intervals are “CGG”. The obtained probability is output to the word recognition unit 408 to be used for word recognition.

The calculated probabilities will be represented by the following Equation 2 to Equation 4 in a vector form.

The probabilities that the phonemes indicated by the first interval 502 are “C”, “G” and “K” included in the phoneme model 416 may be represented in a vector form by Equation 2. Here, the right side of the equation sequentially denotes the probabilities that the phonemes indicated by the first interval 502 are “C”, “G” and “K”, and this is equivalently applied to the following Equation 2 to Equation 4.

prob[1]=[0.8 0.1 0.1] [Equation 2]

Probabilities that phonemes indicated by a second interval 504 are “C”, “G” and “K” included in the phoneme model 416 may be represented in a vector form by the following Equation 3.

prob[2]=[0.05 0.9 0.05] [Equation 3]

Probabilities that phonemes indicated by a third interval 506 are “C”, “G” and “K” included in the phoneme model 416 may be represented in a vector form by the following Equation 4.

prob[3]=[0.05 0.5 0.45] [Equation 4]

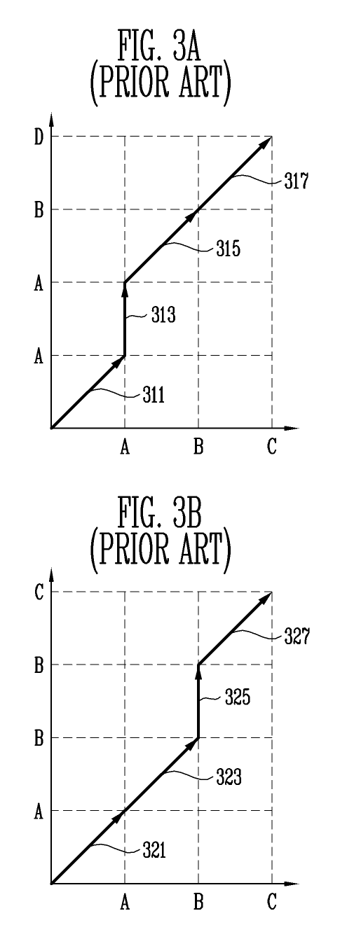

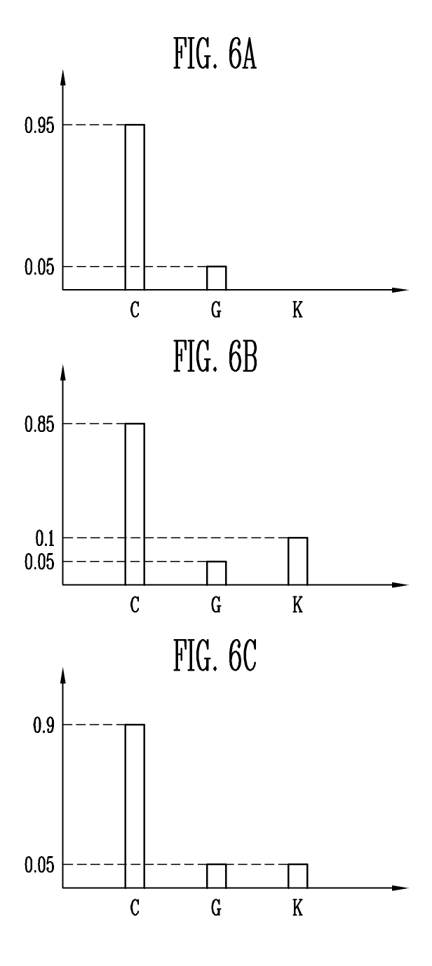

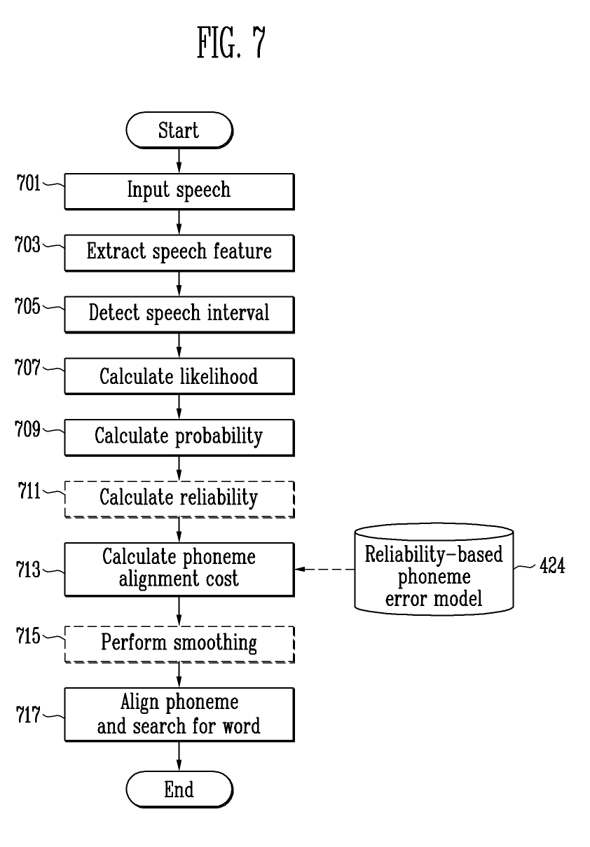

Once again, with reference to FIG. 4, the word recognition unit 408 searches for a word that is most similar to a probability vector sequence indicated by the detected phoneme intervals based on the probability vector prob[q][i] output from the reliability determination unit 406 and the reliability-based phoneme error model 418. The search for a word may be conducted by the above-described DTW method. Here, a phoneme alignment cost caused by substitution of each node of the DTW is calculated based on a probability output from the reliability determination unit 406 and a phoneme recognition probability distribution of the reliability-based phoneme error model 418. The phoneme recognition probability distribution may be calculated by repeatedly performing phoneme alignment as described with reference to FIG. 3. Here, a probability value of Equation 1 with respect to a training DB is accumulated to search for an average probability distribution. Also, the phoneme alignment cost may be calculated by the following Equation 8 or Equation 22. A training process of the reliability-based phoneme error model 418 will be described below with reference to FIGS. 6A to 6C.

FIG. 6A illustrates an example of calculating a probability value of Equation 1 with respect to a phoneme C of the training DB. The phoneme “C” input from the external may be recognized as “C”, “G” and “K”. Referring to FIG. 6A, probabilities that the phoneme “C” is recognized as “C” and “G” in the input phoneme interval of the training DB are 0.95 and 0.05, respectively.

FIG. 6B illustrates an example of calculating a probability value of Equation 1 with respect to another phoneme interval of the phoneme “C” of the training DB. Referring to FIG. 6B, probabilities that the phoneme “C” is recognized as “C”, “G” and “K” are 0.85, 0.5 and 0.1, respectively.

FIG. 6C illustrates a result of updating the reliability-based phoneme error model 418, in which phoneme recognition probability distributions are calculated to an average of phoneme recognition probabilities after calculating probabilities that the phoneme “C” of the training DB is recognized as each phoneme in the entire phoneme intervals. As a result, probabilities that the phoneme “C” is recognized as “C”, “G” and “K” are 0.9, 0.5 and 0.5, respectively.

Table 2 represents an example of a phoneme recognition probability distribution of the trained reliability-based phoneme error model 418.

TABLE 2

| | | | |
|---|---|---|---|
| C | C = 0.9 | G = 0.05 | K = 0.05 |
| G | C = 0.15 | G = 0.5 | K = 0.35 |
| K | C = 0.05 | G = 0.4 | K = 0.55 |

The phoneme recognition probability distribution shown in Table 2 may be represented by Equation 5 to Equation 7.

In Equation 5, probabilities that the phoneme “C” is recognized as “C”, “G” and “K”, respectively, are represented in a vector form. Here, the right side of the equation sequentially denotes probabilities that “C” is recognized as “C”, “G” and “K”, respectively. This is equivalently applied to the following Equation 6 and Equation 7.

W_{C}=[0.9 0.05 0.05] [Equation 5]

In Equation 6, probabilities that a phoneme “G” input from the external is recognized as “C”, “G” and “K”, respectively, are represented in a vector form.

W_{G}=[0.15 0.5 0.35] [Equation 6]

In Equation 7, probabilities that a phoneme “K” input from the external is recognized as “C”, “G” and “K”, respectively, are represented in a vector form.

W_{K}=[0.05 0.4 0.55] [Equation 7]

Once again, with reference to FIG. 4, the word recognition unit 408 calculates the phoneme alignment cost based on the probability calculated by the reliability determination unit 406 and a phoneme recognition probability distribution of the reliability-based phoneme error model 418 according to an exemplary embodiment of the present invention.

The phoneme recognition probability distribution of the reliability-based phoneme error model 418 is used as a weight in calculating the phoneme alignment cost, and the phoneme alignment cost cost(prob[q]|W_{P}) may be defined by the following Equation 8.

$$cost ( prob [ q ] \vert {W}_{P} ) = - ln ( {\sum }_{i = 1}^{N} ( prob [ q ] [ i ] \times {W}_{P} [ i ] ) ) \qquad [ Equation 8 ]$$

The right side of Equation 8 denotes a negative logarithm-sum of the multiplication of probabilities calculated with respect to all phonemes included in the phoneme model 416 of the reliability determination unit 406 and a phoneme recognition probability distribution of the reliability-based phoneme error model 418. The higher the probability becomes, the lower the phoneme alignment cost becomes, and thus the negative logarithm is used in the equation. W_{P} denotes a pre-trained phoneme recognition probability distribution with respect to a phoneme p included in the phoneme model 416. W_{P}[i] denotes an average probability value of an i^{th} phoneme of the phoneme recognition probability distribution pre-trained with respect to the phoneme p included in the phoneme model 416.

The phoneme alignment cost may be represented by the following Equation 9 to Equation 11 by applying the probability and weight of each phoneme interval described by the above exemplary embodiments to the equation for calculating phoneme alignment cost represented by Equation 8.

In Equation 9, probabilities that the detected phoneme interval, i.e., the first interval 502, corresponds to each phoneme included in the phoneme model 416 and a phoneme recognition probability distribution of the reliability-based phoneme error model 418 with respect to the phoneme “C” as a weight are used to calculate a phoneme alignment cost.

$$\begin{matrix}cost ( prob [ 1 ] \vert {W}_{C} ) = - ln ( {\sum }_{i = 1}^{N} ( prob [ 1 ] [ i ] \times {W}_{C} [ i ] ) ) \\ = - ln \{ ( 0.8 \times 0.9 ) + \\ ( 0.1 \times 0.05 ) + ( 0.1 \times 0.05 ) \} \\ = - ln ( 0.73 ) \\ = 0.3147\end{matrix} \qquad [ Equation 9 ]$$

Referring to Equation 9, when the first interval 502 is substituted by the phoneme “C”, the phoneme alignment cost equals 0.3147.

In Equation 10, probabilities that the detected phoneme interval, i.e., the first interval 502, corresponds to each phoneme included in the phoneme model 416 and a phoneme recognition probability distribution of the reliability-based phoneme error model 418 with respect to the phoneme “G” as a weight are used to calculate a phoneme alignment cost.

$$\begin{matrix}cost ( prob [ 1 ] \vert {W}_{G} ) = - ln ( {\sum }_{i = 1}^{N} ( prob [ 1 ] [ i ] \times {W}_{G} [ i ] ) ) \\ = - ln \{ ( 0.8 \times 0.15 ) + \\ ( 0.1 \times 0.5 ) + ( 0.1 \times 0.35 ) \} \\ = - ln ( 0.205 ) \\ = 0.5874\end{matrix} \qquad [ Equation 10 ]$$

Referring to Equation 10, when the first interval 502 is substituted by the phoneme “G”, a phoneme alignment cost equals 0.5874.

In Equation 11, probabilities that the detected phoneme interval, i.e., the first interval 502, corresponds to each phoneme included in the phoneme model 416 and a phoneme recognition probability distribution of the reliability-based phoneme error model 418 with respect to the phoneme “K” as a weight are used to calculate a phoneme alignment cost.

$$\begin{matrix}cost ( prob [ 1 ] \vert {W}_{K} ) = - ln ( {\sum }_{i = 1}^{N} ( prob [ 1 ] [ i ] \times {W}_{K} [ i ] ) ) \\ = - ln \{ ( 0.8 \times 0.05 ) + \\ ( 0.1 \times 0.4 ) + ( 0.1 \times 0.55 ) \} \\ = - ln ( 0.135 ) \\ = 2.0024\end{matrix} \qquad [ Equation 11 ]$$

Referring to Equation 11, when the first interval 502 is substituted by the phoneme “K”, the phoneme alignment cost equals 2.0024.

Accordingly, the phoneme “C”, which has the lowest phoneme alignment cost as a result of Equation 9 to Equation 11, is determined as the phoneme of the first interval 502.

Similarly, each phoneme alignment cost of phonemes “C”, “G” and “K” with respect to a second interval 504 is represented by the following Equation 12 to Equation 14.

In Equation 12, a phoneme alignment cost is calculated when the second interval 504 is substituted by the phoneme “C”.

$$\begin{matrix}cost ( prob [ 2 ] \vert {W}_{C} ) = - ln ( {\sum }_{i = 1}^{N} ( prob [ 2 ] [ i ] \times {W}_{C} [ i ] ) ) \\ = - ln ( 0.0925 ) \\ = 2.3805\end{matrix} \qquad [ Equation 12 ]$$

In Equation 13, a phoneme alignment cost is calculated when the second interval 504 is substituted by the phoneme “G”.

$$\begin{matrix}cost ( prob [ 2 ] \vert {W}_{G} ) = - ln ( {\sum }_{i = 1}^{N} ( prob [ 2 ] [ i ] \times {W}_{G} [ i ] ) ) \\ = - ln ( 0.4750 ) \\ = 0.7444\end{matrix} \qquad [ Equation 13 ]$$

In Equation 14, a phoneme alignment cost is calculated when the second interval 504 is substituted by the phoneme “K”.

$$\begin{matrix}cost ( prob [ 2 ] \vert {W}_{K} ) = - ln ( {\sum }_{i = 1}^{N} ( prob [ 2 ] [ i ] \times {W}_{K} [ i ] ) ) \\ = - ln ( 0.39 ) \\ = 0.9416\end{matrix} \qquad [ Equation 14 ]$$

As a result, the phoneme “G” that has the lowest phoneme alignment cost as a result of Equation 12 to Equation 14 is determined as the phoneme of the second interval 504.

Similarly, each phoneme alignment cost of phonemes “C”, “G” and “K” with respect to the third interval 506 is calculated by the following Equation 15 to Equation 17.

In Equation 15, a phoneme alignment cost is calculated when the third interval 506 is substituted by the phoneme “C”.

$$\begin{matrix}cost ( prob [ 3 ] \vert {W}_{C} ) = - ln ( {\sum }_{i = 1}^{N} ( prob [ 3 ] [ i ] \times {W}_{C} [ i ] ) ) \\ = - ln ( 0.0925 ) \\ = 2.3805\end{matrix} \qquad [ Equation 15 ]$$

In Equation 16, a phoneme alignment cost is calculated when the third interval 506 is substituted by the phoneme “G”.

$$\begin{matrix}cost ( prob [ 3 ] \vert {W}_{G} ) = - ln ( {\sum }_{i = 1}^{N} ( prob [ 3 ] [ i ] \times {W}_{G} [ i ] ) ) \\ = - ln ( 0.4150 ) \\ = 0.8794\end{matrix} \qquad [ Equation 16 ]$$

In Equation 17, a phoneme alignment cost is calculated when the third interval 506 is substituted by the phoneme “K”.

$$\begin{matrix}cost ( prob [ 3 ] \vert {W}_{K} ) = - ln ( {\sum }_{i = 1}^{N} ( prob [ 3 ] [ i ] \times {W}_{K} [ i ] ) ) \\ = - ln ( 0.45 ) \\ = 0.7985\end{matrix} \qquad [ Equation 17 ]$$

Accordingly, the phoneme “K” that has the lowest phoneme alignment cost as a result of Equation 15 to Equation 17 is determined as the phoneme of the third interval 506.

Therefore, the word recognition unit 408 of the present invention determines phoneme sequences with respect to the phoneme intervals detected based on the results calculated by Equation 9 to Equation 16 as “CGK”.

When phoneme sequences are determined based on a probability, in which only likelihood represented by Equation 1 is used, the input phoneme sequences are determined as “CGG”. However, when a pre-trained phoneme recognition probability distribution represented by Equation 8 is additionally used, the input phoneme sequences are determined as “CGK”. That is, the present invention has an advantage in that much information such as a probability calculated by the reliability determination unit 406, a phoneme recognition probability distribution of the pre-trained reliability-based phoneme error model 418, etc. is used to more precisely perform phoneme recognition.

However, phoneme boundaries detected by the phoneme interval detector 404 may be different from actual phoneme boundaries due to various factors inducing performance deterioration such as performance and noise environment of the phoneme interval detector 404, and a difference between training and evaluation environments of the reliability-based phoneme error model 418. Furthermore, a probability calculated by the reliability determination unit 406 may be different from an actual probability. Thus, proper smoothing should be performed on the probability and phoneme recognition probability distribution used for Equation 8.

Therefore, considering the performance and noise environment of the phoneme interval detector 404 and a difference between the training and evaluation environments of the reliability-based phoneme error model 418, smoothing should be performed on the probability represented by Equation 8 by the word recognition unit 408. Taking into account the above factors, the phoneme alignment cost of Equation 8 may be redefined by Equation 18.

$$cost ( prob [ q ] \vert {W}_{P} ) = - ln ( {\sum }_{i = 1}^{N} ( {( prob [ q ] [ i ] )}^{α} \times {( {W}_{P} [ i ] )}^{β} ) ) \qquad [ Equation 18 ]$$

Here, “α” denotes a parameter in which the performance and noise environment of the phoneme interval detector 404 are taken into account, and “β” denotes a parameter in which the training and evaluation environments of the reliability-based phoneme error model 418 are taken into account.

When it is assumed that “α is 0.5 and β is 0.3”, and phoneme alignment costs of phonemes “G” and “K” in the third interval 506 are calculated using the above values, the results may be represented by Equation 19 and Equation 20, respectively.

In Equation 19, parameters, in which “α is 0.5 and β is 0.3”, are again applied to calculate a phoneme alignment cost when the third interval 506 represented by Equation 16 is substituted by the phoneme “G”.

$$\begin{matrix}cost ( prob [ 3 ] \vert {W}_{G} ) = - ln ( {\sum }_{i = 1}^{N} ( {( prob [ 3 ] [ i ] )}^{0.5} \times {( {W}_{G} [ i ] )}^{0.3} ) ) \\ = - ln \{ ( {0.05}^{0.5} \times {0.15}^{0.3} ) + \\ ( {0.5}^{0.5} \times {0.5}^{0.3} ) + ( {0.45}^{0.5} \times {0.35}^{0.3} ) \} \\ = - ln ( 1.1904 ) \\ = - 0.1742\end{matrix} \qquad [ Equation 19 ]$$

In Equation 20, parameters, in which “α is 0.5 and β is 0.3”, are again applied to calculate a phoneme alignment cost when the third interval 506 represented by Equation 17 is substituted by the phoneme “K”.

$$\begin{matrix}cost ( prob [ 3 ] \vert {W}_{K} ) = - ln ( {\sum }_{i = 1}^{N} ( {( prob [ 3 ] [ i ] )}^{0.5} \times {( {W}_{K} [ i ] )}^{0.3} ) ) \\ = - ln \{ ( {0.05}^{0.5} \times {0.05}^{0.3} ) + \\ ( {0.5}^{0.5} \times {0.4}^{0.3} ) + ( {0.45}^{0.5} \times {0.55}^{0.3} ) \} \\ = - ln ( 1.1888 ) \\ = - 0.1729\end{matrix} \qquad [ Equation 20 ]$$

Comparing Equation 19 with Equation 20, the phoneme alignment cost of the phoneme “G” is lower in the third interval 506. Therefore, according to the phoneme alignment cost, in which the parameters “α=0.5 and β=0.3” are applied, the third interval 506 corresponds to the phoneme “G”. This result is different from that the third interval 506 corresponds to the phoneme “K” determined according to Equation 15 to Equation 17 calculated based on the definition of Equation 8.

Therefore, more precise phoneme recognition results may be obtained by using the parameters α and β, in which the performance and environment of the phoneme interval detector 404 and the reliability-based phoneme error model 418 are taken into account, rather than the probability calculated by the reliability determination unit 406 and the phoneme recognition probability distribution of the reliability-based phoneme error model 418 as represented by Equation 8.

Meanwhile, the probability equation defined by Equation 1 needs to be modified. This is because a probability value may be changed due to a range of number recognition when a probability calculated by the reliability determination unit 406 is extremely low. For example, when a probability calculated by the reliability determination unit 406 is “0.0000000001”, the probability may be changed to “0” due to the range of number recognition.

Accordingly, to increase degrees of accuracy, the probability equation defined by Equation 1 is taken in logarithm. For example, when a probability is “0.0000000001”, the probability is taken in natural logarithm to calculate a reliability of “−23.0258”. This results in the increased degree of accuracy, avoiding a problem due to the range of number recognition.

The reliability determination unit 406 calculates reliability using the probability represented by Equation 1.

When the probability equation defined by Equation 1 is taken in the natural logarithm to define the reliability feature[q][i], the result may be represented by Equation 21.

$$\begin{matrix}feature [ q ] [ i ] = ln ( prob [ q ] [ i ] ) \\ = ln ( \frac{likelihood [ q ] [ i ]}{{\sum }_{j = 1}^{N} likelihood [ q ] [ j ]} )\end{matrix} \qquad [ Equation 21 ]$$

Here, the phoneme alignment cost caused by the substitution of each node of DTW may be calculated based on the reliability output from the reliability determination unit 406 and the phoneme recognition probability distribution of the reliability-based phoneme error model 418. Here, the reliability-based phoneme error model 418 is also taken in the natural logarithm to calculate the distribution.

When a phoneme alignment cost is calculated by the word recognition unit 408 using the reliability defined by Equation 21, a changed value should be compensated for by taking the natural logarithm.

When Equation 8 is modified to calculate a phoneme alignment cost using the reliability defined by Equation 21, the equation is defined by Equation 22, and resultant values represented by Equation 8 and Equation 22 become the same. Therefore, the word recognition unit 408 calculates the phoneme alignment cost based on the following equation defined by Equation 22.

$$cost ( feature [ q ] \vert {W}_{P} ) = - ln ( {\sum }_{i = 1}^{N} ( {e}^{feature [ q ] [ i ]} \times {e}^{{W}_{P} [ i ]} ) ) \qquad [ Equation 22 ]$$

Equation 22 for calculating a phoneme alignment cost should be also redefined by applying the parameters α and β, in which the performance and noise environment of the phoneme interval detector 404 and the training and evaluation environment of the reliability-based phoneme error model 418 are taken into account, as represented by Equation 18. Accordingly, when Equation 22 is modified, it is represented by Equation 23. Therefore, the word recognition unit 408 calculates the phoneme alignment cost based on the equation represented by Equation 23.

$$cost ( feature [ q ] \vert {W}_{P} ) = - ln ( {\sum }_{i = 1}^{N} ( {( {e}^{feature [ q ] [ i ]} )}^{α} \times {( {e}^{{W}_{P} [ i ]} )}^{β} ) ) \qquad [ Equation 23 ]$$

Meanwhile, the likelihood calculated by the viterbi decoding is defined by a multi-Gaussian probability model, and the multi-Gaussian probability is defined in the form of an exponential function. Here, when a probability that a phoneme is continuously appeared over all frames with respect to every Gaussian function can be obtained to calculate the final likelihood, each probability having each feature data corresponding to every selected acoustic model should be multiplied. In this case, the resultant value may be extremely small, and thus the accuracy may not be reliable. Therefore, the probabilities are calculated in a logarithm domain to be added to each other to avoid being extremely small, which is caused by the multiplication of the probabilities, and thus the accuracy is enhanced. When Equation 1 is modified to increase the accuracy, it is represented by Equation 24. Therefore, the reliability determination unit 406 calculates a probability prob[q][i] based on an equation represented by Equation 24.

$$prob [ q ] [ i ] = \frac{{e}^{ln likelihood [ q ] [ i ]}}{{\sum }_{j = 1}^{N} {e}^{ln likelihood [ q ] [ j ]}} \qquad [ Equation 24 ]$$

The reason why both a numerator and a denominator in the right side of Equation 24 are in the form of an exponential function is to calculate in a logarithm domain to compensate for the changed value.

Meanwhile, a process of calculating the phoneme alignment cost using the probability represented by Equation 24 is the same as that performed by Equation 8 and Equation 18.

As Equation 1 is modified to Equation 21 to avoid an accuracy problem due to the range of number recognition, Equation 24 is modified to define Equation 25. The reliability determination unit 406 calculates the reliability feature[q][i] according to Equation 25.

$$feature [ q ] [ i ] = ln ( \frac{{e}^{ln likelihood [ q ] [ i ]}}{{\sum }_{j = 1}^{N} {e}^{ln likelihood [ q ] [ j ]}} ) \qquad [ Equation 25 ]$$

A calculating process of the phoneme alignment cost based on the reliability as shown in Equation 25 is the same as that performed by Equation 22 and Equation 23.

Meanwhile, although the reliability of Equation 21 and Equation 25 are defined using the likelihood, they may be defined by values output from the phoneme recognition implemented by a neutral network instead of a general phoneme recognizer. Furthermore, the reliability may also be defined by a log-likelihood ratio that is a ratio of an output value of an ANTI model generally used for utterance verification and an output value of the triphone model.

FIG. 7 is a flowchart illustrating a method of recognizing speech according to an exemplary embodiment of the present invention. A detailed description of the method of recognizing speech according to an exemplary embodiment of the present invention will be made below with reference to FIG. 7, and any repeated descriptions on the apparatus for recognizing speech which have been made with reference to FIGS. 4 to 6 will be omitted.

In step 703, a speech feature extraction unit 402 extracts speech feature data from speech input in step 701 and outputs the extracted speech feature data to a phoneme interval detector 404.

In step 705, the phoneme interval detector 404 determines a boundary between phonemes based on the speech feature data output from the speech feature extraction unit 402 to detect each phoneme interval.

In step 707, a reliability determination unit 406 compares a pattern of each phoneme interval detected in step 705 with that of each phoneme included in a phoneme model 416, calculates likelihood, and proceeds with the subsequent step 709.

In step 709, the reliability determination unit 406 calculates probabilities that each phoneme interval detected based on the likelihood calculated in step 707 corresponds to each phoneme included in the phoneme model 416, and proceeds with the subsequent step 711.

In step 711, the reliability determination unit 406 calculates reliability of each phoneme interval detected based on the probabilities calculated in step 709 with respect to each phoneme included in the phoneme model 416 and outputs the calculated reliability to a word recognition unit 408.

In step 713, the word recognition unit 408 calculates a phoneme alignment cost based on the reliability output from the reliability determination unit 406 and a phoneme recognition probability distribution of the reliability-based phoneme error model 418 that is pre-trained, and proceeds with the subsequent step 715.

In step 715, the word recognition unit 408 applies parameters, in which the performance and noise environment of the phoneme interval detector 404 and training and evaluation environments of the reliability-based phoneme error model 418 are taken into account, to the phoneme alignment cost calculated in step 713 to calculate a phoneme alignment cost again, and proceeds with the subsequent step 717.

In step 717, the word recognition unit 408 performs phoneme alignment based on the phoneme alignment cost calculated in step 715, and determines a word that is most similar to the input speech.

Here, step 715 may be omitted from the above processes, and when step 715 is omitted, step 717, in which the word recognition unit 408 performs phoneme alignment based on the phoneme alignment cost calculated in step 713 and determines a word that is most similar to the input speech, is performed after step 713 is performed.

Meanwhile, after the probability is calculated in step 709, step 713 may be performed with skipping step 711. Here, in step 713, the word recognition unit 408 calculates the phoneme alignment cost based on the probability output from the reliability determination unit 406 and the phoneme recognition probability distribution of the reliability-based phoneme error model 418 that is pre-trained, and proceeds with step 715.

Here, step 715 may be omitted, and when step 715 is omitted, step 717, in which the word recognition unit 408 performs phoneme alignment based on the phoneme alignment cost calculated in step 713 and determines a word that is most similar to the input speech, is performed after step 713 is performed.

As described above, in the present invention, reliability with respect to phoneme-recognized phoneme sequences is calculated, and performance of speech recognition may be enhanced using the calculated results. Also, in the present invention, a phoneme recognition probability distribution that is used in calculating the reliability with respect to the phoneme-recognized phoneme sequences is calculated, and the performance of speech recognition can be enhanced using the calculated results.

In the drawings and specification, there have been disclosed typical preferred embodiments of the invention and, although specific terms are employed, they are used in a generic and descriptive sense only and not for purposes of limitation. As for the scope of the invention, it is to be set forth in the following claims. Therefore, it will be understood by those of ordinary skill in the art that various changes in form and details may be made therein without departing from the spirit and scope of the present invention as defined by the following claims.

What is claimed is:

1. A method of recognizing speech comprising, the steps of:
determining a boundary between phonemes included in character sequences that are phonetically input to detect each phoneme interval;
calculating reliability according to a probability that a phoneme indicated by the detected phoneme interval corresponds to a phoneme included in a predefined phoneme model;
calculating a phoneme alignment cost with respect to the character sequences based on the calculated reliability and a pre-trained and stored phoneme recognition probability distribution; and
performing phoneme alignment based on the calculated phoneme alignment cost to perform speech recognition on the input character sequences.

2. The method of claim 1, wherein the step of calculating the reliability comprises the steps of comparing a pattern of each phoneme interval with a pattern of each phoneme included in the predefined phoneme model to calculate likelihood, and calculating the reliability based on the calculated likelihood.

3. The method of claim 2, wherein the reliability(feature[q][i]) is calculated by the following equation:
$$feature [ q ] [ i ] = prob [ q ] [ i ] = \frac{likelihood [ q ] [ i ]}{{\sum }_{j = 1}^{N} likelihood [ q ] [ j ]}$$
wherein feature[q][i] denotes reliability according to a probability that a phoneme indicated by a q^{th} phoneme interval of the entire detected phoneme intervals corresponds to an i^{th} phoneme of N phonemes included in a phoneme model,
prob[q][i] denotes a probability that the phoneme indicated by the q^{th} phoneme interval of the entire detected phoneme intervals corresponds to the i^{th} phoneme of N phonemes included in the phoneme model,
likelihood[q][i] denotes a likelihood between the phoneme indicated by the q^{th} phoneme interval of the entire detected phoneme intervals and the i^{th} phoneme of N phonemes included in a phoneme model, and
$${\sum }_{j = 1}^{N} likelihood [ q ] [ j ]$$
denotes a sum of the likelihood between the phoneme indicated by the q^{th} phoneme interval of the entire detected phoneme intervals and each phoneme of N phonemes included in the phoneme model.

4. The method of claim 2, wherein the reliability(feature[q][i]) is calculated by the following equation:
$$feature [ q ] [ i ] = prob [ q ] [ i ] = \frac{{e}^{ln likelihood [ q ] [ i ]}}{{\sum }_{j = 1}^{N} {e}^{ln likelihood [ q ] [ j ]}}$$
wherein feature[q][i] denotes reliability according to a probability that a phoneme indicated by a q^{th} phoneme interval of the entire detected phoneme intervals corresponds to an i^{th} phoneme of N phonemes included in a phoneme model,
prob[q][i] denotes a probability that the phoneme indicated by the q^{th} phoneme interval of the entire detected phoneme intervals corresponds to the i^{th} phoneme of N phonemes included in the phoneme model,
e^{lnlikelihood[q][i]}=likelihood[q][i] denotes a likelihood between the phoneme indicated by the q^{th} phoneme interval of the entire detected phoneme intervals and the i^{th} phoneme of N phonemes included in the phoneme model, and
$${\sum }_{j = 1}^{N} {e}^{ln likelihood [ q ] [ j ]} = {\sum }_{j = 1}^{N} likelihood [ q ] [ j ]$$
denotes a sum of the likelihoods between the phoneme indicated by the q^{th} phoneme interval of the entire detected phoneme intervals and each phoneme of N phonemes included in the phoneme model.

5. The method of claim 3, wherein the phoneme alignment cost cost(feature[q]|W_{P}) is calculated by the following equation:
$$cost ( feature [ q ] \vert {W}_{P} ) = - ln ( {\sum }_{j = 1}^{N} ( {W}_{P} [ i ] \times feature [ q ] [ i ] ) )$$
wherein feature[q] denotes a reliability vector having reliability elements according to probabilities that the phoneme indicated by the q^{th} phoneme interval of the entire detected phoneme intervals corresponds to each phoneme of N phonemes included in the phoneme model,
W_{P} denotes a phoneme recognition probability distribution that is pre-trained with respect to a phoneme p included in the phoneme model,
W_{P}[i] denotes an average probability value of the i^{th} phoneme of the phoneme recognition probability distribution that is pre-trained with respect to the phoneme p included in the phoneme model, and
feature[q][i] denotes reliability according to the probability that the phoneme indicated by the q^{th} phoneme interval of the entire detected phoneme intervals corresponds to the i^{th} phoneme of N phonemes included in the phoneme model.

6. The method of claim 5, wherein the reliability(feature[q][i]) is calculated by the following equation:
$$feature [ q ] [ i ] = ln ( prob [ q ] [ i ] ) = ln ( \frac{likelihood [ q ] [ i ]}{{\sum }_{j = 1}^{N} likelihood [ q ] [ j ]} )$$
wherein feature[q][i] denotes reliability according to a probability that the phoneme indicated by the q^{th} phoneme interval of the entire detected phoneme intervals corresponds to the i^{th} phoneme of N phonemes included in the phoneme model,
prob[q][i] denotes a probability that the phoneme indicated by the q^{th} phoneme interval of the entire detected phoneme intervals corresponds to the i^{th} phoneme of N phonemes included in the phoneme model,
likelihood[q][i] denotes a likelihood between the phoneme indicated by the q^{th} phoneme interval of the entire detected phoneme intervals and the i^{th} phoneme of N phonemes included in the phoneme model, and
$${\sum }_{j = 1}^{N} likelihood [ q ] [ j ]$$
denotes a sum of the likelihoods between the phoneme indicated by the q^{th} phoneme interval of the entire detected phoneme intervals and each phoneme of N phonemes included in the phoneme model.

7. The method of claim 5, wherein the reliability(feature[q][i]) is calculated by the following equation:
$$feature [ q ] [ i ] = ln ( prob [ q ] [ i ] ) + ln ( \frac{{e}^{ln likelihood [ q ] [ i ]}}{{\sum }_{j = 1}^{N} {e}^{ln likelihood [ q ] [ j ]}} )$$
wherein feature[q][i] denotes reliability according to a probability that the phoneme indicated by the q^{th} phoneme interval of the entire detected phoneme intervals corresponds to the i^{th} phoneme of N phonemes included in the phoneme model,
prob[q][i] denotes a probability that the phoneme indicated by the q^{th} phoneme interval of the entire detected phoneme intervals corresponds to the i^{th} phoneme of N phonemes included in the phoneme model,
e^{lnlikelihood[q][i]}=likelihood[q][i] denotes a likelihood between the phoneme indicated by the q^{th} phoneme interval of the entire detected phoneme intervals and the i^{th} phoneme of N phonemes included in the phoneme model, and
$${\sum }_{j = 1}^{N} {e}^{ln likelihood [ q ] [ j ]} = {\sum }_{j = 1}^{N} likelihood [ q ] [ j ]$$
denotes a sum of the likelihoods between the phoneme indicated by the q^{th} phoneme interval of the entire detected phoneme intervals and each phoneme of N phonemes included in the phoneme model.

8. The method of claim 6, wherein the phoneme alignment cost(cost feature[q]|W_{P})) is calculated by the following equation:
$$cost ( feature [ q ] \vert {W}_{P} ) = - ln ( {\sum }_{i = 1}^{N} ( {e}^{feature [ q ] [ i ]} \times {e}^{{W}_{P} [ i ]} ) )$$
wherein feature[q] denotes a reliability vector having reliability elements according to probabilities that the phoneme indicated by the q^{th} phoneme interval of the entire detected phoneme intervals corresponds to each phoneme of N phonemes included in the phoneme model
W_{P} denotes a phoneme recognition probability distribution that is pre-trained with respect to the phoneme p included in the phoneme model,
W_{P}[i] denotes an average probability value of an i^{th} phoneme of the phoneme recognition probability distribution that is pre-trained with respect to the phoneme p included in the phoneme model, and
feature[q][i] denotes reliability according to a probability that the phoneme indicated by the q^{th} phoneme interval of the entire detected phoneme intervals corresponds to the i^{th} phoneme of N phonemes included in the phoneme model.

9. The method of claim 1, further comprising the step of smoothing the phoneme alignment cost by taking into account at least one of accuracy and noise environment of the phoneme interval detection, and a difference between evaluation and training environments for calculating the phoneme recognition probability distribution.

10. The method of claim 5, wherein the phoneme alignment cost (cost(feature[q]|W_{P})) is calculated by the following equation:
$$cost ( feature [ q ] \vert {W}_{P} ) = - ln ( {\sum }_{i = 1}^{N} ( {( feature [ q ] [ i ] )}^{α} \times {( {W}_{P} [ i ] )}^{β} ) )$$
wherein feature[q] denotes a reliability vector having reliability elements according to probabilities that the phoneme indicated by the q^{th} phoneme interval of the entire detected phoneme intervals corresponds to each phoneme of N phonemes included in the phoneme model,
W_{P} denotes a phoneme recognition probability distribution that is pre-trained with respect to the phoneme p included in the phoneme model,
W_{P}[i] denotes an average probability value of the i^{th} phoneme of the phoneme recognition probability distribution that is pre-trained with respect to the phoneme p included in the phoneme model,
feature[q][i] denotes reliability according to a probability that a phoneme indicated by the q^{th} phoneme interval of the entire detected phoneme intervals corresponds to the i^{th} phoneme of N phonemes included in the phoneme model,
α denotes a parameter reflecting noise environment and accuracy of the phoneme interval detection, and
β denotes a parameter reflecting difference between evaluation and training environments for calculating the phoneme recognition probability distribution.

11. The method of claim 8, wherein the phoneme alignment cost cost(feature[q]|W_{P}) is calculated by the following equation:
$$cost ( feature [ q ] \vert {W}_{P} ) = - ln ( {\sum }_{i = 1}^{N} ( {( {e}^{feature [ q ] [ i ]} )}^{α} \times {( {e}^{{W}_{P} [ i ]} )}^{β} ) )$$
wherein feature[q] denotes a reliability vector having reliability elements according to probabilities that the phoneme indicated by the q^{th} phoneme interval of the entire detected phoneme intervals corresponds to each phoneme included in the phoneme model comprising N phonemes,
W_{P} denotes a phoneme recognition probability distribution that is pre-trained with respect to the phoneme p included in the phoneme model,
W_{P}[i] denotes an average probability value of the i^{th} phoneme of the phoneme recognition probability distribution that is pre-trained with respect to the phoneme p included in the phoneme model,
feature[q][i] denotes reliability according to a probability that the phoneme indicated by the q^{th} phoneme interval of the entire detected phoneme intervals corresponds to the i^{th} phoneme of N phonemes included in a phoneme model,
α denotes a parameter reflecting noise environment and accuracy of the phoneme interval detection, and
β denotes a parameter reflecting a difference between evaluation and training environments for calculating the phoneme recognition probability distribution.

12. The method of claim 1, further comprising the step of calculating the phoneme recognition probability distribution by phonetically receiving phoneme sequences for calculating the phoneme recognition probability distribution and accumulating determination results that a phoneme included in the phonetically input phoneme sequences is recognized as a phoneme among a plurality of phonemes that are predefined.

13. The method of claim 12, wherein the step of determining that a phoneme included in the phonetically input phoneme sequences is recognized as a phoneme among a plurality of phonemes that are predefined comprises a step of calculating a cost for aligning the phonetically input phoneme sequences with respect to answer phoneme sequences, so that a phoneme that requires the lowest cost is recognized as the phoneme.

14. An apparatus for recognizing speech, comprising:
a phoneme interval detector for detecting each phoneme interval by determining a boundary between phonemes included in phonetically input character sequences;
a reliability determination unit for calculating reliability according to probabilities that a phoneme indicated by each detected phoneme interval corresponds to each phoneme included in a predefined phoneme model;
a reliability-based phoneme error model for storing a phoneme recognition probability distribution obtained by pre-training that a phonetically input phoneme is recognized as a phoneme; and
a word recognition unit for calculating a phoneme alignment cost with respect to the character sequences based on the calculated reliability and the phoneme recognition probability distribution, and performing phoneme alignment based on the calculated phoneme alignment cost to perform speech recognition with respect to the character sequences.

15. The apparatus of claim 14, wherein the reliability determination unit calculates a likelihood between the phoneme indicated by each phoneme interval and each phoneme included in the phoneme model, and calculates the reliability based on the calculated likelihood.

16. The apparatus of claim 15, wherein the word recognition unit calculates the reliability(feature[q][i]) by the following equation:
$$feature [ q ] [ i ] = prob [ q ] [ i ] = \frac{{e}^{ln likelihood [ q ] [ i ]}}{{\sum }_{j = 1}^{N} {e}^{ln likelihood [ q ] [ j ]}}$$
wherein feature[q][i] denotes reliability according to a probability that the phoneme indicated by the q^{th} phoneme interval of the entire detected phoneme intervals corresponds to the i^{th} phoneme of N phonemes included in the phoneme model,
prob[q][i] denotes a probability that the phoneme indicated by the q^{th} phoneme interval of the entire detected phoneme intervals is the i^{th} phoneme of N phonemes included in the phoneme model,
e^{lnlikelihood[q][i]}=likelihood[q][i] denotes a likelihood between the phoneme indicated by the q^{th} phoneme interval of the entire detected phoneme intervals and the i^{th} phoneme of N phonemes included in the phoneme model, and
$${\sum }_{j = 1}^{N} {e}^{ln likelihood [ q ] [ j ]} = {\sum }_{j = 1}^{N} likelihood [ q ] [ j ]$$
denotes a sum of the likelihoods between the phoneme indicated by the q^{th} phoneme interval of the entire detected phoneme intervals and each phoneme of N phonemes included in the phoneme model.

17. The apparatus of claim 14, wherein the reliability determination unit calculates the reliability(feature[q][i]) by the following equation:
$$feature [ q ] [ i ] = ln ( prob [ q ] [ i ] ) = ln ( \frac{{e}^{ln likelihood [ q ] [ i ]}}{{\sum }_{j = 1}^{N} {e}^{ln likelihood [ q ] [ j ]}} )$$
wherein feature[q][i] denotes reliability according to a probability that the phoneme indicated by the q^{th} phoneme interval of the entire detected phoneme intervals corresponds to the i^{th} phoneme of N phonemes included in the phoneme model,
prob[q][i] denotes a probability that the phoneme indicated by the q^{th} phoneme interval of the entire detected phoneme intervals corresponds to the i^{th} phoneme of N phonemes included in the phoneme model,
e^{lnlikelihood[q][i]}=likelihood[q][i] denotes a likelihood between a phoneme that a q^{th} phoneme interval of the entire detected phoneme intervals indicates and an i^{th} phoneme of N phonemes included in the phoneme model, and
$${\sum }_{j = 1}^{N} {e}^{ln likelihood [ q ] [ j ]} = {\sum }_{j = 1}^{N} likelihood [ q ] [ j ]$$
denotes a sum of the likelihoods between the phoneme indicated by the q^{th} phoneme interval of the entire detected phoneme intervals and each phoneme of N phonemes included in the phoneme model.

18. The apparatus of claim 17, wherein the word recognition unit calculates the phoneme alignment cost(cost(feature[q]|W_{P})) by the following equation:
$$cost ( feature [ q ] \vert {W}_{P} ) = - ln ( {\sum }_{i = 1}^{N} ( {e}^{feature [ q ] [ i ]} \times {e}^{{W}_{P} [ i ]} ) )$$
wherein feature[q] denotes a reliability vector having reliability elements according to probabilities that the phoneme indicated by the q^{th} phoneme interval of the entire detected phoneme intervals corresponds to each phoneme of N phonemes included in the phoneme model,
W_{P} denotes a phoneme recognition probability distribution that is pre-trained with respect to the phoneme p included in the phoneme model,
W_{P}[i] denotes an average probability value of the i^{th} phoneme of the phoneme recognition probability distribution that is pre-trained with respect to the phoneme p included in the phoneme model, and
feature[q][i] denotes reliability according to a probability that the phoneme indicated by the q^{th} phoneme interval of the entire detected phoneme intervals corresponds to the i^{th} phoneme of N phonemes included in the phoneme model.

19. The apparatus of claim 14, wherein the word recognition unit performs smoothing on the phoneme alignment cost by taking into account at least one of performance of the phoneme interval detector, noise environment and a difference between the evaluation environment and training environment of the reliability-based phoneme error model.

20. The apparatus of claim 18, wherein the word recognition unit calculates the phoneme alignment cost(cost(feature[q]|W_{P})) by the following equation:
$$cost ( feature [ q ] \vert {W}_{P} ) = - ln ( {\sum }_{i = 1}^{N} ( {( {e}^{feature [ q ] [ i ]} )}^{α} \times {( {e}^{{W}_{P} [ i ]} )}^{β} ) )$$
wherein feature[q] denotes a reliability vector having reliability elements according to probabilities that the phoneme indicated by the q^{th} phoneme interval of the entire detected phoneme intervals corresponds to each phoneme of N phonemes included in the phoneme model,
W_{P} denotes a phoneme recognition probability distribution that is pre-trained with respect to the phoneme p included in the phoneme model,
W_{P}[i] denotes an average probability value of the i^{th} phoneme of the phoneme recognition probability distribution that is pre-trained with respect to the phoneme p included in the phoneme model,
feature[q][i] denotes reliability according to a probability that the phoneme indicated by the q^{th} phoneme interval of the entire detected phoneme intervals corresponds to the i^{th} phoneme of N phonemes included in the phoneme model,
α denotes a parameter reflecting noise environment and performance of the phoneme interval detector, and
β denotes a parameter reflecting a difference between the evaluation and training environments for calculating a phoneme recognition probability distribution.
